(19) United States
(12) Patent Application Publication
(10) Pub. No.: US 2015/0254488 A1
(43) Pub. Date: Sep. 10, 2015

(54) CODE SYMBOL READING APPARATUS AND METHOD FOR READING CODE SYMBOL

(71) Applicant: TOSHIBA TEC KABUSHIKI KAISHA, Tokyo (JP)

(72) Inventor: Hidehiro Naito, Mishima (JP)

(21) Appl. No.: 14/631,926

(22) Filed: Feb. 26, 2015

(30) Foreign Application Priority Data
Mar. 5, 2014 (JP) 2014-043124

(51) Int. Cl. G06K 7/14

(52) U.S. Cl. CPC G06K 7/1439; G06K 2007/10495

(57) ABSTRACT

In accordance with one embodiment, a code reading apparatus comprises a camera, illuminator and an image capturing control section. The camera photographs a code symbol at fixed time intervals to capture an image of the code symbol. The illuminator illuminates an image capturing area of the camera. The image capturing control section controls the camera and the illuminator so that the camera captures images in a synchronous frame in which an image capturing timing of the camera is synchronized with a turning-on timing of the illuminator and in an asynchronous frame in which the image capturing timing of the camera is not synchronized with the turning-on timing of the illuminator.

### CROSS-REFERENCE TO RELATED APPLICATION

This application is based upon and claims the benefit of priority from Japanese Patent Application No. 2014-043124, filed Mar. 5, 2014, the entire contents of which are incorporated herein by reference.

### FIELD

Embodiments described herein relate generally to a code symbol reading apparatus and a method for reading a code symbol.

### BACKGROUND

A commodity recognition apparatus such as a POS (Point Of Sales) terminal reads a commodity identification code such as a barcode to specify a commodity. The commodity recognition apparatus photographs the commodity to which a code symbol is attached with a code symbol reading apparatus which uses a CCD (Charge Coupled Device) and the like to acquire an image containing the code symbol, and then analyzes the acquired image to recognize the code to specify the commodity with the code. Generally, the code symbol reading apparatus illuminates the commodity held by an operator of the commodity recognition apparatus, and then scans the reflected light to acquire the image of the commodity.

However, in a case of reading the code symbol displayed on a liquid crystal screen by a conventional code symbol reading apparatus, there is a case that the illumination light is reflected on the liquid crystal screen and thus, the code symbol displayed on the liquid crystal screen cannot be read.

### BRIEF DESCRIPTION OF THE DRAWINGS

FIG. 1 is an external view illustrating a store checkout system according to one embodiment;

FIG. 2 is a schematic view illustrating an image capturing section of a commodity recognition apparatus according to the embodiment;

FIG. 3 is a block diagram illustrating the electronic components in the store checkout system according to the embodiment; and

FIG. 4 is a diagram illustrating the operations of the image capturing section according to the embodiment.

### DETAILED DESCRIPTION

In accordance with one embodiment, a code symbol reading apparatus comprises a camera, an illuminator and an image capturing control section. The camera photographs a code symbol at fixed time intervals to capture an image of the code symbol. The illuminator illuminates an image capturing area of the camera. The image capturing control section controls the camera and the illuminator so that the camera captures images in a synchronous frame in which an image capturing timing of the camera is synchronized with a turning-on timing of the illuminator and in an asynchronous frame in which the image capturing timing of the camera is not synchronized with the turning-on timing of the illuminator.

Hereinafter, the embodiment of the commodity recognition apparatus equipped with a code symbol reading apparatus is described with reference to the accompanying drawings. In the embodiment, the commodity recognition apparatus is applied to a store checkout system arranged at a checkout counter in a store such as a supermarket and the like.

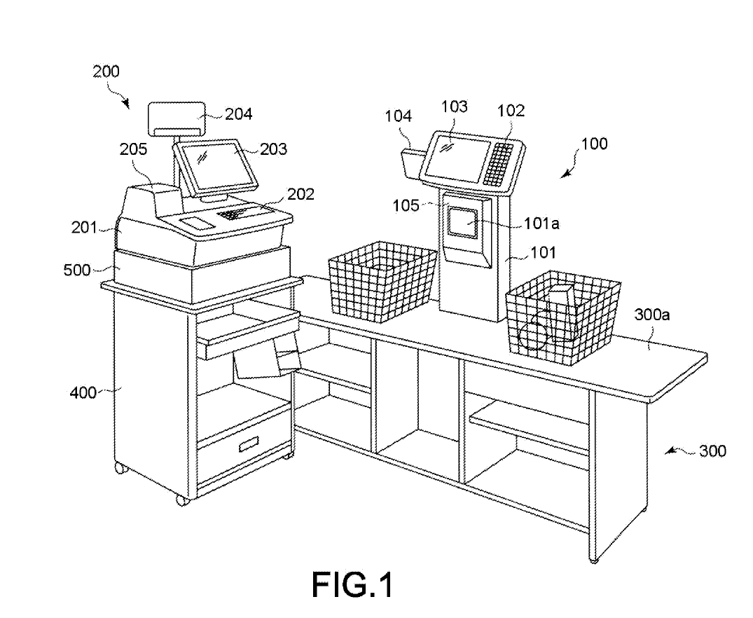

FIG. 1 is an external view illustrating a store checkout system according to the present embodiment. The store checkout system includes a commodity recognition apparatus 100 and a POS (Point Of Sales) terminal 200. The commodity recognition apparatus 100 is arranged on a checkout counter 300. The POS terminal 200 is arranged on a drawer 500 placed on a register table 400. The commodity recognition apparatus 100 and the POS terminal 200 are electrically connected with each other through a communication cable (not shown). The POS terminal 200 may be arranged on an automatic change dispensing machine instead of the drawer 500.

The commodity recognition apparatus 100 includes a housing 101, a keyboard 102, a touch panel 103, a display for customer 104 and an image capturing section 105. The commodity recognition apparatus 100 can read a commodity identification code such as a barcode attached (assigned) to a commodity to recognize the commodity.

The housing 101, formed in a flat box shape, stands on the checkout counter 300. The housing 101 supports the keyboard 102, the touch panel 103 and the display for customer 104 at the upper end thereof. The housing 101 further supports the image capturing section 105 at the inside thereof.

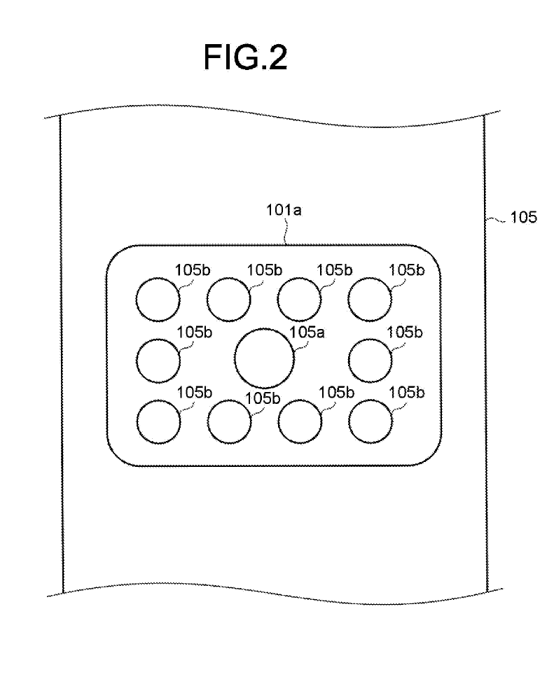

The housing 101 includes a reading window 101a at a front surface thereof. As shown in FIG. 2, the image capturing section 105 in the housing 101 includes a camera 105a arranged opposite to the reading window 101a in the housing 101, and a plurality of illuminators 105b arranged around the camera 105a. The camera 105a photographs a commodity (object) positioned in front of the reading window 101a through the reading window 101a. The illuminators 105b illuminate the commodity through the reading window 101a when photographing the commodity.

The POS terminal 200 includes a housing 201, a keyboard 202, a display for operator 203, a display for customer 204 and a printer 205.

The housing 201 supports the keyboard 202 in such a manner that part of the keyboard 202 is exposed to the outside. The housing 201 supports the display for operator 203 and the display for customer 204 in such a manner that they are exposed to the outside. The housing 201 further supports the printer 205 at the inside thereof.

The checkout counter 300 includes an elongated top plate 300a. The checkout counter 300 divides the space or area at which the counter 300 is arranged into a customer passage (rear side in FIG. 1) and an operator space (front side in FIG. 1) along the longitudinal direction of the top plate 300a. The housing 101 of the commodity recognition apparatus 100 is located at the center portion of the top plate 300a in the longitudinal direction in a state that the keyboard 102, the touch panel 103 and, the reading window 101a of the housing 201 are directed to the operator space while the display for customer 104 is directed to the customer passage. An area of the upper surface of the top plate 300a at the upstream side of the commodity recognition apparatus 100 in the customer moving direction is used as a space for placing commodities that are not yet sales-registered while the area at the downstream side is used as a space for placing commodities that are sales-registered through the commodity recognition apparatus 100.

The register table 400 is arranged in an L-shape with the checkout counter 300 in the operator space such that it locates at the downstream side of the checkout counter 300 in the moving direction of the customer along the customer passage.

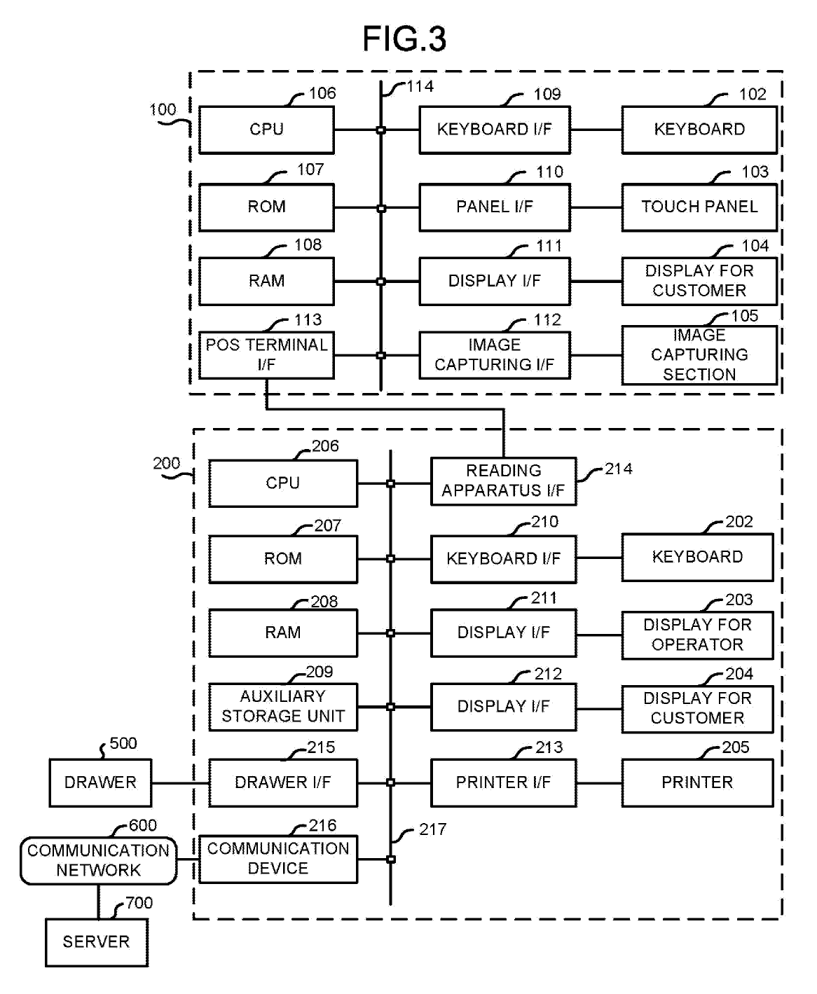

FIG. 3 is a block diagram illustrating the electronic components in the store checkout system shown in FIG. 1. Same or similar components in FIG. 3 as those shown in FIG. 1 are indicated by the same reference numerals and thus a repetitive description is not provided.

The commodity recognition apparatus 100 includes the keyboard 102, the touch panel 103, the display for customer 104, the image capturing section 105, a CPU (Central Processing Unit) 106, a ROM (Read Only Memory) 107, a RAM (Random Access Memory) 108, a keyboard interface (keyboard I/F) 109, a panel interface (panel I/F) 110, a display interface (display I/F) 111, an image capturing interface (image capturing I/F) 112, a POS terminal interface (POS terminal I/F) 113 and a bus line 114 as the electronic components. The bus line 114 including an address bus, a data bus and the like connects the CPU 106, the ROM 107, the RAM 108, the keyboard interface 109, the panel interface 110, the display interface 111, the image capturing interface 112 and the POS terminal interface 113 with each other.

The keyboard 102 including a plurality of key switches outputs a command indicating the content of an operation to each key switch by an operator.

The touch panel 103 includes a display device such as an LCD (Liquid Crystal Display) and a transparent two-dimensional touch sensor overlaid on the display screen of the display device. The display device displays an image under the control of the CPU 106. For example, the commodity recognition apparatus 100 displays guidance to the operator on the display device of the touch panel 103.

The two-dimensional touch sensor of the touch panel 103 detects the contact position (X-Y) on the display screen of the display device touched by the operator, and outputs the detection result as a coordinate data.

Further, a notification section such as a speaker and the like may be arranged in the touch panel 103. The speaker of the touch panel 103 outputs a speech under the control of the CPU 106. For example, the commodity recognition apparatus 100 outputs a guidance speech to the operator through the speaker of the touch panel 103. The touch panel 103 functions as a notification section for giving various notifications or guidance to the operator.

The display for customer 104 displays a character string or image under the control of the CPU 106. The display for customer 104 is used to display various character strings or images that are indicated to the customers. The display for customer 104 may be, for example, a fluorescent tube display or an LCD and the like.

As stated above, the image capturing section 105 is provided with a camera 105a including an imaging lens and a CCD (Charge Coupled Device) image capturing element serving as an area image sensor and illuminators 105b arranged around the lens of the camera 105a as shown in FIG. 2. The imaging lens focuses an image of an image capturing area on the CCD image capturing element. The image capturing area refers to an area focused on the CCD image capturing element through the image capturing lens from the reading window 101a. The camera 105a acquires an image (frame image) of the image capturing area and outputs the frame image.

The image capturing section 105 functions as an image capturing control section which controls the camera 105a and the illuminators 105b. To realize this function, the image capturing section 105 includes a computer (not shown) consisting of a CPU, a ROM, a RAM and the like. The image capturing section 105 controls operations of the camera 105a and the illuminators 105b through the image capturing control section realized by the computer which executes a program.

The image capturing section 105 outputs a scanning signal to the image sensor of the camera 105a to enable the camera 105a to capture an image. The camera 105a opens the shutter of the image sensor through a time period during which it receives the scanning signal to capture a frame image and outputs the captured frame image. The image capturing section 105 outputs the scanning signals to the camera 105a at fixed time intervals. In this way, the image capturing section 105 can enable the camera 105a to output the frame images at the fixed time intervals.

The illuminator 105b includes a light source, for example, an LED, a cold cathode-ray tube, a fluorescent lamp or an incandescent lamp. The image capturing section 105 turns on the light source of each illuminator 105b to illuminate the commodity held in front of the reading window 101a with the light from each illuminator 105b through the reading window 101a.

The image capturing section 105 outputs a strobe signal to the light source of the illuminator 105b through a time period to turn on the light source. The light source of the illuminator 105b emits light via the reading window 101a throughout the time period during which it receives the strobe signal. The image capturing section 105 outputs the strobe signals to each illuminator 105b at fixed time intervals. In this way, the image capturing section 105 enables each illuminator 105b to intermittently turn on its light source.

The image capturing section 105 recognizes the commodity identification code from the frame image output from the camera 105a. For example, in a case in which the commodity identification code is a barcode, the image capturing section 105 carries out a predetermined barcode analysis on the frame image output from the camera 105a to recognize the barcode (commodity identification code). The image capturing section 105 thus functions as a code symbol reading apparatus.

The CPU 106 is a central part of a computer. The CPU 106 controls each section of the commodity recognition apparatus 100 to realize various operations of the commodity recognition apparatus 100 according to an operating system, a middleware and an application program stored in the ROM 107 and the RAM 108.

The ROM 107 is a main storage part of the computer. The ROM 107 stores the operating system mentioned above. As occasion demands, the ROM 107 also stores the middleware and the application program mentioned above, and data referred to with the CPU 106 which carries out various processing.

The RAM 108 is also a main storage part of the computer. The RAM 108 stores data referred to with the CPU 106 which carries out various processing. The RAM 108 is further used as a so-called work area for temporarily storing data used by the CPU 106 which carries out various processing.

The application programs stored in the ROM 107 include a control program relating to a commodity reading processing described later. The transfer of the commodity recognition apparatus 100 is generally carried out in a state in which the control program is stored in the ROM 107. Alternatively, an auxiliary storage device such as an EEPROM (Electronic Erasable Programmable Read Only Memory), a hard disk drive or an SSD (Solid State Drive) is arranged in the commodity recognition apparatus 100, and the commodity recognition apparatus 100 may be transferred in a state in which the control program is stored in the auxiliary storage device. Still alternatively, the commodity recognition apparatus 100 can be transferred in a state in which the control program is not stored in the ROM 107 or the auxiliary storage device. In this case, the control program is transferred in a state in which it is recorded in a removable recording medium such as a magnetic disc, a magnetic optical disk, an optical disk, a semiconductor memory and the like, or transferred through a network, and then the control program is written in the auxiliary storage device of the commodity recognition apparatus 100 transferred separately as described above.

The keyboard interface 109 mediates the transfer of data between the keyboard 102 and the CPU 106. The keyboard interface 109 can be used as an interface of a well-known device based on, for example, a PS/2 standard or a USB (Universal Serial Bus) standard.

The panel interface 110 mediates the transfer of video signals and data between the touch panel 103 and the CPU 106. The panel interface 110 includes an interface for the display device and an interface for the touch sensor. The interface for the display device can be used as an interface of a well-known device based on, for example, a VGA (Video Graphics Array) standard (analog RGB standard), a DVI (Digital Video Interface) standard or an LVDS (Low Voltage Differential Signaling) standard. The interface for the touch sensor can be used as an interface of a well-known device based on, for example, a USB standard or an RS-232C (Recommended Standard 232C) standard.

The display interface 111 mediates the transfer of video signals between the display for customer 104 and the CPU 106. The display interface 111 can be used as an interface of a well-known device based on, for example, a USB standard or an RS-232C standard in a case in which the display for customer 104 is a fluorescent tube display; and can be used as an interface of a well-known device based on, for example, a VGA standard, a DVI standard or an LVDS standard in a case in which the display for customer 104 is an LCD.

The image capturing interface 112 mediates the transfer of data between the image capturing section 105 and the CPU 106. The image capturing interface 112 can be used as an interface of a well-known device based on, for example, a USB standard or an IEEE (Institute of Electrical and Electronic Engineers) 1394 standard.

The POS terminal interface 113 mediates the transfer of data between the POS terminal 200 and the CPU 106. The POS terminal interface 113 can be used as an interface of a well-known device based on, for example, a USB standard or an RS-232C standard.

The POS terminal 200 includes the keyboard 202, the display for operator 203, the display for customer 204, the printer 205, a CPU 206, a ROM 207, a RAM 208, an auxiliary storage unit 209, a keyboard interface (keyboard I/F) 210, display interfaces (display I/F) 211 and 212, a printer interface (printer I/F) 213, a reading apparatus interface (reading apparatus I/F) 214, a drawer interface (drawer I/F) 215, a communication device 216 and a bus line 217 as electronic components. The bus line 217 including an address bus, a data bus and the like connects the CPU 206, the ROM 207, the RAM 208, the auxiliary storage unit 209, the keyboard interface 210, the display interface 211, the display interface 212, the printer interface 213, the reading apparatus interface 214, the drawer interface 215 and the communication device 216 with each other.

The keyboard 202 including a plurality of key switches outputs a command indicating the content of an operation by an operator on each key switch.

The display for operator 203 displays an image under the control of the CPU 206. The display for operator 203 is used to display various images indicated to the operator. The display for operator 203 is, for example, an LCD.

The display for customer 204 displays character strings or images under the control of the CPU 206. The display for customer 204 is used to display various character strings or images indicated to the customer. The display for customer 204 is, for example, a fluorescent tube display or an LCD.

The printer 205 prints a receipt image indicating the content of the transaction on a receipt paper under the control of the CPU 206. The printer 205 may be an existing printer of various well-known types, for example, a thermal printer.

The CPU 206 is a central part of a computer. The CPU 206 controls each section to realize various operations of the POS terminal 200 according to an operating system, a middleware and an application program stored in the ROM 207 and the RAM 208.

The ROM 207 is a main storage part of the computer. The ROM 207 stores the operating system mentioned above. As occasion demands, the ROM 207 also stores the middleware and the application program mentioned above, and a data referred to with the CPU 206 which carries out various processing.

The RAM 208 is also a main storage part of the computer. The RAM 208 stores data referred to with the CPU 206 which carries out various processing. The RAM 208 is further used as a so-called work area for temporarily storing data used by the CPU 206 which carries out various processing. Part of the storage area of the RAM 208 is used as a commodity list area for managing information of the commodity which is sales-registered.

The auxiliary storage unit 209 is an auxiliary storage part of the computer. The auxiliary storage unit 209, which is, for example, a hard disk drive or an SSD, stores data used by the CPU 206 which carries out various processing and data generated through the processing carried out by the CPU 206.

The keyboard interface 210 mediates the transfer of data between the keyboard 202 and the CPU 206. The keyboard interface 210 can be used as an interface of a well-known device based on, for example, a PS/2 standard or a USB standard.

The display interface 211 mediates the transfer of video signals between the display for operator 203 and the CPU 206. The display interface 211 can be used as an interface of a well-known device based on, for example, a VGA standard, a DVI standard or an LVDS standard.

The display interface 212 mediates the transfer of video signals between the display for customer 204 and the CPU 206. The display interface 212 can be used as an interface of a well-known device based on, for example, a USB standard or an RS-232C standard in a case in which the display for customer 204 is a fluorescent tube display; and can be used as an interface of a well-known device based on, for example, a VGA standard, a DVI standard or an LVDS standard in a case in which the display for customer 204 is an LCD.

The printer interface 213 mediates the transfer of data between the printer 205 and the CPU 206. The printer interface 213 can be used as an interface of a well-known device based on, for example, a USB standard, an RS-232C standard or an IEEE1284 standard (so-called Centronics Standard) and the like.

The reading apparatus interface 214 mediates the transfer of data between the commodity recognition apparatus 100 and the CPU 206. The reading apparatus interface 214 can be used as an interface of a well-known device based on a standard of the POS terminal interface 113.

The drawer interface 215 outputs a drive signal for opening the drawer 500 to the drawer 500 in response to a drawer opening instruction from the CPU 206.

The communication device 216 communicates with a server 700 through a communication network 600. The communication device 216 is, for example, an existing LAN communication device.

The server 700 stores a database in which information of the commodity indicating the commodity name, the unit price and the like is associated with the commodity identification code.

The commodity recognition apparatus 100 recognizes the commodity identification code from the commodity image through the image capturing section 105. The commodity recognition apparatus 100 accesses the database of the server 700 to read out the commodity name, the unit price and the like associated with the commodity identification code recognized from the commodity image.

The processing for registering the information indicating the commodity name, the unit price and the commodity identification code into the database may be carried out by the commodity recognition apparatus 100 or other general personal computer.

The commodity recognition apparatus 100 may have an operational constitution in which the database of the server 700 is downloaded in advance. In this case, the commodity recognition apparatus 100 downloads the database of the server 700 to a storage section such as the auxiliary storage unit 209 in advance. The commodity recognition apparatus 100 acquires the commodity name, the unit price and the like associated with the recognized commodity identification code by retrieving the database stored in the auxiliary storage unit 209.

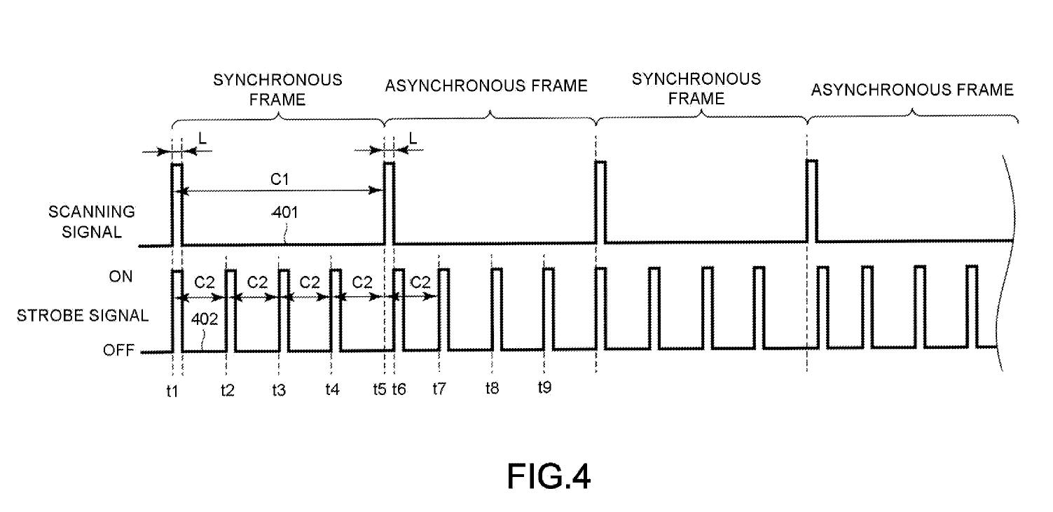

FIG. 4 is a diagram illustrating an example of the operations of the image capturing section 105 acting as a code symbol reading apparatus. A chart 401 indicates the scanning signals input to the image sensor of the camera 105a. In other words, the chart 401 indicates the image capturing timings of the camera 105a. A chart 402 indicates the strobe signals input to the light source of the illuminator 105b. In other words, the chart 402 indicates the turning-on timings of the illuminator 105b.

The image capturing section 105 inputs the scanning signals having a length L to the image sensor of the camera 105a at fixed time intervals C1 from the timing t1.

The time interval C1 is determined according to a frame rate at which the camera 105a captures images. The time interval C1 is equal to the length of one frame of image. Further, the length L is determined according to the time period (shutter speed) through which the shutter of the image sensor of the camera 105a opens.

With such a constitution, the camera 105a opens the shutter for a time period corresponding to the length L to capture a frame image of one frame at the respective time interval C1.

The image capturing section 105 inputs the strobe signals to the light source of the illuminator 105b at fixed time intervals C2 from the timing t1. In this way, the image capturing section 105 intermittently turns on the illuminators 105b between the image capturing timings of the camera 105a. The time interval C2 is determined according to the period of intermittently turning-on of the illuminator 105b. The time interval C1 is an integral multiple of the time interval C2.

In the example shown in FIG. 4, the time interval C1 is four times as long as the time interval C2. The camera 105a captures one frame image and the illuminator 105b is intermittently turned on for four times in one of the time intervals C1. Specifically, the image capturing section 105 respectively inputs the strobe signals to the light source of the illuminator 105b at the timing t1, the timing t2 to which a fixed time identical to the time interval C2 elapses from the timing t1, the timing t3 to which the fixed time elapses from the timing t2 and the timing t4 to which the fixed time elapses from the timing t3.

The turning-on timing of the illuminator 105b is synchronized with the image capturing timing of the camera 105a at the timing t1. Thus, the illuminator 105b can illuminate the commodity held in front of the reading window 101a with light at the image capturing timing of the camera 105a. As a result, the camera 105a can capture the light (image), reflected on the commodity at the timing t1, which is emitted from the illuminator 105b. As described above, the image capturing section 105 controls the strobe signal in a manner as stated above to set a synchronous frame at a timing at which the image capturing timing of the camera 105a is synchronized with the turning-on timing of the illuminator 105b.

With such a constitution, the image capturing section 105 can capture, in the synchronous frame, a sharp image of an object such as a commodity with a code symbol held over the reading window 101a. Therefore, the image capturing section 105 can acquire a commodity image from which the code symbol on the commodity is easily analyzed in a case in which the image capturing timing is synchronized with the turning-on timing of the illuminator 105b.

The ON/OFF operations (intermittent illumination) of the illuminator 105b at the timings t2, t3 and t4 respectively generate dummy lights which do not make the operator of the commodity recognition apparatus 100 perceive flickering caused by the ON/OFF illuminations of the illuminator 105b in synchronization with the image capturing timings of the camera 105a. It is preferable that the intermittent turning-on of the illuminator 105b is carried out at a frequency higher than the frequency at which flickering is visible with human eyes.

As shown in FIG. 4, the image capturing section 105 inputs no strobe signal to the light source of the illuminator 105b at a timing t5 to which the time identical to the time interval C2 elapses from the timing t4, but inputs the strobe signal at a timing t6 to which a time corresponding to the length L delays from the timing t5. The image capturing section 105 shifts the turning-on timing of the illuminator 105b by a time corresponding to the shutter speed of the camera 105a from the image capturing timing of the camera 105a.

In this case, the turning-on timing of the illuminator 105b is not synchronized with the image capturing timing of the camera 105a at the timing t5. Thus, the camera 105a can capture a frame image in a state in which no light is emitted from the illuminator 105b at the timing t5. In other words, the image capturing section 105 controls the strobe signal in a manner as stated above to set an asynchronous frame at a timing at which the image capturing timing of the camera 105a is not synchronized with the turning-on timing of the illuminator 105b.

With such a constitution, the image capturing section 105 can capture, in the asynchronous frame, an image in a state in which no light from the illuminator 105b is emitted to an object such as a commodity held over the reading window 101a. Therefore, the image capturing section 105 can capture an image of an object having a high reflectance such as a liquid crystal screen through the camera 105a in a case in which the image capturing timing of the camera 105a is not synchronized with the turning-on timing of the illuminator 105b.

The customer shows a code symbol such as a barcode or a two-dimensional code on the liquid crystal screen of a portable terminal such as a mobile phone which is carried by the customer to receive an exchangeable point or indicate a discount coupon when purchasing commodities. At this time, the image capturing section 105 can capture an image of the code displayed on the liquid crystal screen in a state in which the code can be analyzed easily.

Further, the image capturing section 105 respectively inputs the strobe signals to the light source of the illuminator 105b at a timing t7 to which a fixed time identical to the time interval C2 elapses from the timing t5, a timing t8 to which the fixed time elapses from the timing t7 and a timing t9 to which the fixed time elapses from the timing t8. The image capturing section 105 sets back the turning-on timing of the illuminator 105b to the original timing of intermittent turning-on within the same frame after shifting the timing of intermittent turning-on of the illuminator 105b. In this way, the image capturing section 105 can prevent human eyes from perceiving flickering caused by the intermittent turning-on of the illuminator 105b.

In the example shown in FIG. 4, the image capturing section 105 controls the camera 105a and the illuminators 105b in such a manner that the asynchronous frame and the synchronous frame are produced alternately. However, the image capturing section 105 may alternately produce the asynchronous frame and the synchronous frame at any ratio. For example, the image capturing section 105 sets that the ratio of the asynchronous frame to the synchronous frame is high in a case in which there is a high probability that the liquid crystal screen is held over the reading window 101a; as a result, the efficiency or accuracy of reading the code symbol on the liquid crystal screen can be improved. On the other hand, the image capturing section 105 sets that the ratio of the synchronous frame to the asynchronous frame is high in a case in which there is a high probability that the code symbol printed on a sheet attached to the commodity is held over the reading window 101a; as a result, the efficiency or accuracy of reading the code symbol attached to the commodity can also be improved.

It is exemplified in the embodiment described above that the image capturing section 105 shifts the strobe signal by a time corresponding to the shutter speed of the camera 105a from the rising edge of the scanning signal of the asynchronous frame; however, it is not limited to this. The image capturing section 105 may shift the strobe signal at any degree in time as long as it is within a range in which the scanning signal is not synchronized with the strobe signal.

The functions described in the embodiment above, which are not limited to be constituted by hardware, may be realized by a computer that reads programs in which each function is written, using software. Alternatively, each function may be constituted by selecting either of the software or the hardware properly.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A code reading apparatus comprising:
a camera configured to photograph a code symbol at fixed time intervals to capture an image of the code symbol;
an illuminator configured to illuminate an image capturing area of the camera; and
an image capturing control section configured to control the camera and the illuminator so that the camera captures images in a synchronous frame in which an image capturing timing of the camera is synchronized with a turning-on timing of the illuminator and in an asynchronous frame in which the image capturing timing of the camera is not synchronized with the turning-on timing of the illuminator.

2. The code reading apparatus according to claim 1, wherein the image capturing control section intermittently turns on the illuminator in a time period between the image capturing timings of the camera in such a manner that the timing of the intermittent turning-on of the illuminator is shifted from the image capturing timing of the camera to produce the asynchronous frame.

3. The code reading apparatus according to claim 2, wherein the image capturing control section shifts the timing of the intermittent turning-on of the illuminator from the start of the image capturing timing of the camera by a time corresponding to a shutter speed of the camera to produce the asynchronous frame.

4. The code reading apparatus according to claim 2, wherein the image capturing control section sets back the shifted timing of the intermittent turning-on of the illuminator to an original timing of the intermittent turning-on in the same frame.

5. The code reading apparatus according to claim 3, wherein the image capturing control section sets back the shifted timing of the intermittent turning-on of the illuminator to an original timing of intermittent turning-on in the same frame.

6. The code reading apparatus according to claim 1, wherein the image capturing control section produces the synchronous frame and the asynchronous frame, alternately.

7. A method for reading a code symbol by a code reading apparatus having a camera which captures an image of a code symbol and an illuminator which illuminates an image capturing area of the camera, including:
controlling the camera and illuminator so that the camera captures images in a synchronous frame in which an image capturing timing of the camera is synchronized with a turning-on timing of the illuminator and in an asynchronous frame in which the image capturing timing of the camera is not synchronized with the turning-on timing of the illuminator.
